(19) United States
(12) Patent Application Publication
(10) Pub. No.: US 2022/0385212 A1
(43) Pub. Date: Dec. 1, 2022

(54) PIEZOELECTRIC LINEAR MOTOR

(71) Applicant: TAURUS TECHNOLOGIES HOLDINGS, INC., Barrington, IL (US)

(72) Inventors: Marta MAGNUSSON, Grimsby (CA); Stefan MAGNUSSON, Grimsby (CA)

(73) Assignee: TAURUS TECHNOLOGIES HOLDINGS, INC., Barrington, IL (US)

(21) Appl. No.: 17/879,589

(22) Filed: Aug. 2, 2022

Related U.S. Application Data
(63) Continuation-in-part of application No. 16/941,477, filed on Jul. 28, 2020.

(51) Int. Cl. H02N 2/04

(52) U.S. Cl. CPC H02N 2/04

(57) ABSTRACT

A piezoelectric linear motor is disclosed. Piezoelectric actuators, when energized, press stator magnets against opposing rotor magnets which impart a repulsive/attractive force onto a rotor. The rotor is constrained such that it can only move in a linear fashion, and it so moves when the force is imparted to it by the repulsive/attractive force.

### PRIORITY CLAIM/CROSS REFERENCE TO RELATED APPLICATION AND INCORPORATION BY REFERENCE

This application claims priority to U.S. patent application Ser. No. 16/941,477, “BRUSHLESS ELECTRIC MOTOR,” filed Jul. 28, 2020, in the United States Patent and Trademark Office, said application by the same inventive entity, with the entirety of said application being incorporated herein by reference to provide continuity of disclosure.

### BACKGROUND OF THE INVENTION

The present invention relates to a new type of linear electric motor, which for purposes of this application, in this and all following sections, may be abbreviated as “LEM,” known as a piezoelectric linear motor, which for purposes of this application, in this and all following sections, may be abbreviated as “PLM.” Linear motors, both electric and otherwise are known in the art: to be clear, a linear motor is any motor that provides a linear force (as opposed to a rotary torque) to an output load when powered by an input power source. LEM are, in essence, rotary electric motors which have had their rotor (the moving part which drives the output load) and stator (the static part relative to which the rotor, and thus the output load, moves) “unrolled” so as to produce a linear, usually reciprocal, motion as opposed to the rotary motion normally associated with an electric motor.

LEM are subject to the same concerns and inefficiencies as rotary electric motors. Namely, in their usual embodiments they require coils of copper wire and other environmentally sensitive parts, they are not efficient at converting electrical power to linear force, and they are complex to fabricate and repair.

A PLM which required fewer materials than a traditional LEM would be a useful invention.

A PLM motor which was more efficient than traditional LEM would also be a useful invention.

A PLM which was simpler to fabricate and repair than a traditional LEM would likewise be a useful invention.

The present invention addresses these concerns.

### SUMMARY OF THE INVENTION

Among the many objectives of the present invention is the provision of a new type of linear electric motor or LEM known as a piezoelectric linear motor or PLM.

Another objective of the present invention is to provide a PLM which requires fewer environmentally sensitive materials to fabricate than a traditional LEM.

Another objective of the present invention is to provide a PLM which allows reciprocal linear motion in an effective and efficient way.

Yet another objective of the present invention is to provide a PLM which is simpler to fabricate and repair than a traditional LEM.

Other objectives and advantages of the present invention will become apparent to those of ordinary skill in the art upon review of the disclosure hereof.

### BRIEF DESCRIPTION OF THE DRAWINGS

FIG. 1 depicts a perspective view of the preferred embodiment of the invention.

FIG. 2 depicts a cutaway perspective view of the preferred embodiment of the invention.

FIG. 3 depicts a cutaway perspective view of the tension roller component of the invention.

FIG. 4 depicts a perspective view of the tension roller component of the invention.

FIG. 5 depicts a perspective view of the rail component of the invention.

FIG. 6 depicts a perspective view of the carriage component of the invention.

FIG. 7 depicts a perspective view of the preferred embodiment of the invention ready for use.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

Though useful for many applications, the invention will be described as a rail-mounted carriage style PLM. The carriage of the PLM would be operably affixed to the output load and provide a motive force to it. As will be apparent to those of ordinary skill in the art, the actual input power source and output load are not shown, but the PLM will drive any reasonable output load when powered by any reasonable input power load. For purposes of this application, the carriage of the PLM is analogous to the rotor of a rotary electric motor, and may also be referred to as a “rotor,” though it moves in a linear and not rotary fashion. Similarly the rail of the PLM is analogous to the stator of a rotary electric motor, and may also be referred to as a “stator.” It should be noted that the PLM could be fabricated in such a way that the carriage was static relative to the rail assembly and the rail assembly moved upon activation of the piezoelectric actuators. Such an embodiment is also anticipated by the disclosure of this application.

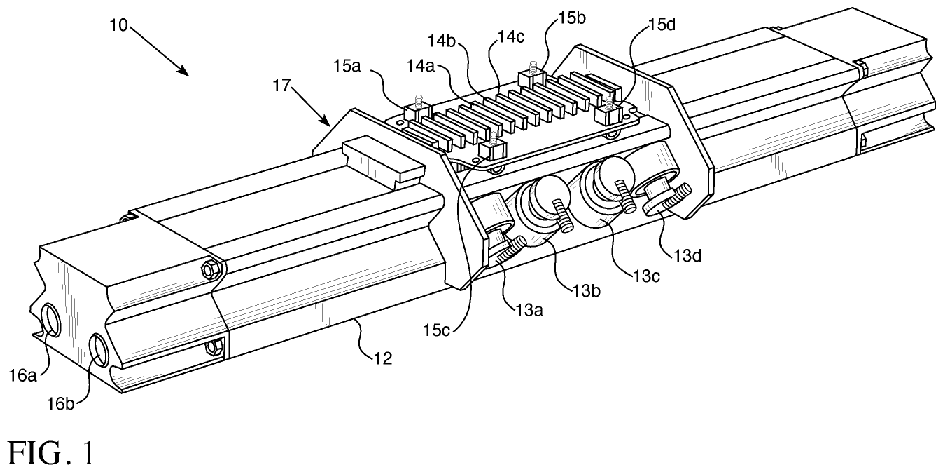

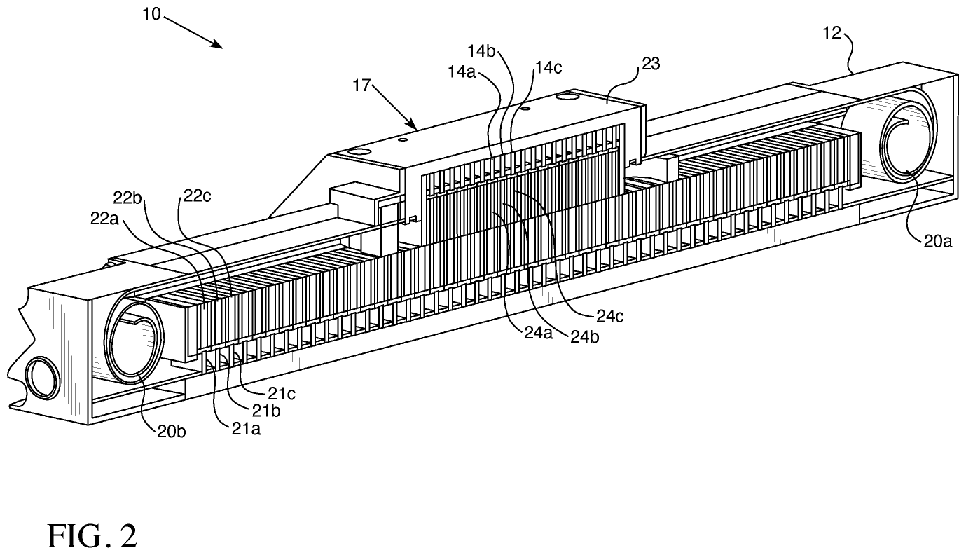

By referring to FIG. 1, the piezoelectric linear motor can be easily understood. PLM 10 comprises rail 12, wherein rail 12 is understood to comprise the entirety of the fixed components/stator component of the PLM, and carriage component 17, where carriage 17 is understood to comprise the entirety of the moving components/rotor of the PLM. In operation, rail 12 remains static relative to some fixed device, e.g. the main body of a reciprocating saw. Carriage 17 moves on rail 12, causing some output load, e.g. the blade of a reciprocating saw (NOT SHOWN,) to move in a linear fashion. The output load may of course be a reciprocating flywheel or transmission of some kind which changes the ultimate direction in which the component to be moved to not be in line with or parallel to the movement of carriage component 10. The precise way in which this is done is described in association with FIG. 2, below.

Also shown in FIG. 1 are tension rollers 13a-13d, carriage piezoelectric actuators 14a-14c, piezoelectric brakes 15a-15d, and rail component access ports 16a-16b. Tension rollers 13a-13d are used to adjust the clearance and tension of rail 12 relative to carriage 17. Carriage piezoelectric actuators 14a-14c (which are optional as will be described in association with FIG. 2, below) actuate carriage magnets 24a-24c (see FIG. 2). Piezoelectric brakes 15a-15d are used to slow or stop the motion of carriage 17 on rail 12 if it is necessary to stop it faster than it would stop on its own if all the piezoelectric actuators were de-energized. Rail access ports 16a and 16b allow access to the interior of rail 12 for power feed wires, lubricant feeds, pneumatic balancing, or any other desired purpose.

FIG. 2 shows the components of PLM 10 as needed for operation. Carriage 17 is now covered by cover 23. Inside rail 12 are rail piezoelectric actuators 21a-21c which are operably affixed to rail magnets 22a-22c. In opposition to the rail magnets are carriage magnets 24a-24c, which are operably affixed to carriage piezoelectric actuators 14a-14c. It should be noted that as is apparent from the figure, there are far more rail piezoelectric actuators and rail magnets than the three numbered elements, just as there are far more carriage piezoelectric actuators and carriage magnets than the numbered elements. It is required that there be at least one piezoelectric actuator, at least one rail magnet, and at least one carriage magnet. It is strongly preferred, but not required, that the rail and carriage magnets extend for as much of the length of the rail and carriage respectively as is reasonably possible. This allows for greater control and more power.

To operate the PLM, a voltage is put across one or more of the piezoelectric actuators by a switching power supply (NOT SHOWN.) As shown, this could be the rail piezoelectric actuators, the carriage piezoelectric actuators, or both. It is preferred, but not required, that both the rail and the carriage have piezoelectric actuators. If both do not have piezoelectric actuators, it is somewhat preferred, but not required, that the piezoelectric actuators be in the rail. The following description will assume that only the rail piezoelectric actuators are being energized for purposes of simplicity.

Putting a voltage across the rail piezoelectric actuators causes them to expand. This in turn pushes the corresponding rail magnets closer to the opposing carriage magnets. If the rail magnets and carriage magnets are properly configured, this will produce a net magnetic force in one direction or the other along the axis of travel of carriage 17. One reason it is preferred to have multiple piezoelectric actuators is that they can be energized in a sequence that will maximize the net magnetic force (e.g. in such a way that the actuations will occur when the magnets are in the optimal opposing positions.)

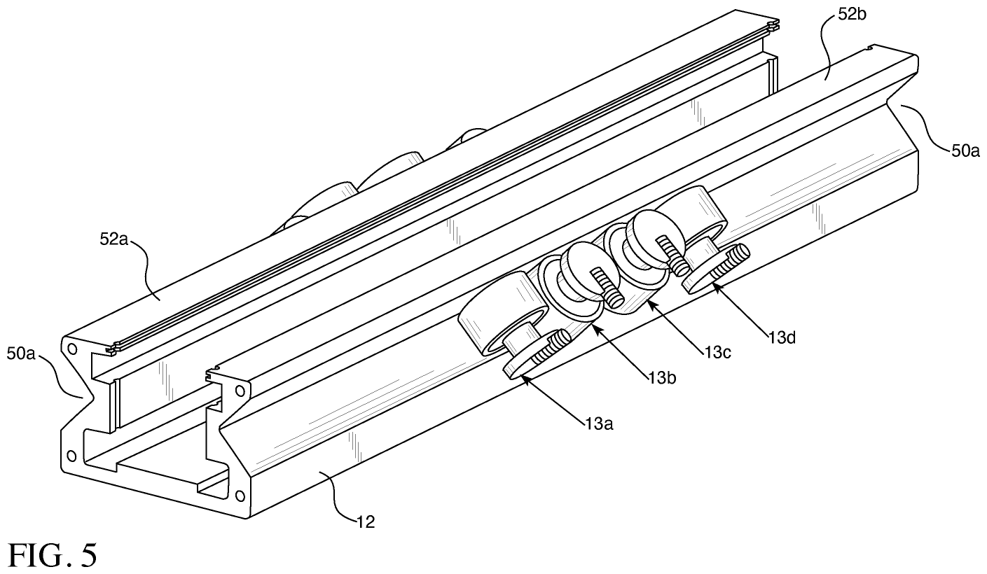

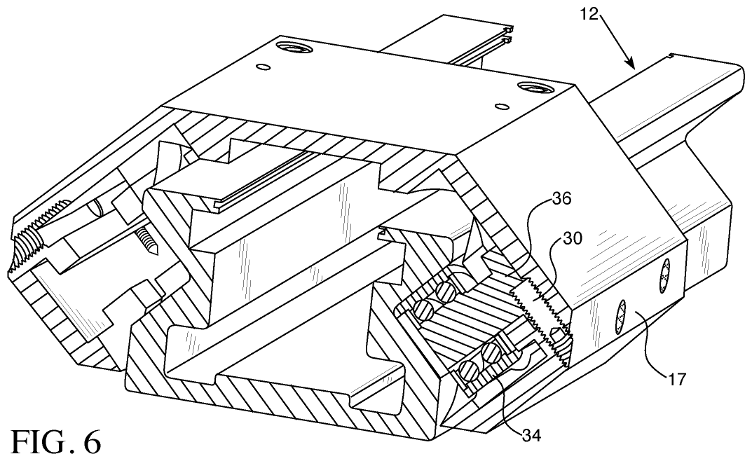

Because carriage 17 cannot move in any direction other than along the axis of travel on rail 12 (see FIGS. 5 and 6) the net magnetic force will tend to push rail 12 in the desired direction along that axis of travel. As carriage 17 moves along rail 12, the rail piezoelectric actuators are continuously energized and de-energized in such a way as to continue to impart a net magnetic force in the desired direction of travel.

Once carriage 17 reaches the limit of travel, it encounters elastic member 20a or 20b. The elastic member absorbs the momentum of carriage 17, preventing undue negative acceleration stresses on the PLM and preserving/recycling some of the momentum of carriage 17 for the return cycle. The rail piezoelectric actuators are then energized and de-energized in such a way as to produce a net magnetic force in the opposite direction of travel. This in turn causes carriage 17 to move in the other direction along rail 12 until it encounters the other elastic member, and the cycle repeats. This imparts a reciprocal linear motion to rail 17, which in turn can be imparted to any operably affixed output load.

To provide additional power, the carriage piezoelectric actuators can also be energized, which will push the rail magnets and the carriage magnets together with more force and/or faster and/or in a pattern which produces more net magnetic force per unit of time. The two sets of actuators can also be alternated to improve efficiency, reduce individual component heating and/or wear, or to more precisely control the motion of carriage 17. It is optional, as noted, to have piezoelectric actuators on both rail 12 and carriage 17: they can be on one, the other, or both as is desired.

Piezoelectric brakes 15a-15d each have a brake shoe operably affixed to a piezoelectric brake actuator. To stop or slow the travel of carriage 17 on rail 12, the piezoelectric brakes actuators are energized. This causes them to expand and push the brake shoe into contact with braking surfaces 52a and 52b (see FIG. 5,) which will create friction between rail 12 and carriage 17, causing the motion of carriage 17 to slow or stop. Piezoelectric brakes 15a-15d can also be used to secure carriage 17 in a desired position on rail 12 for transport or maintenance. A set screw or other adjustment means (NOT SHOWN) can be used to raise or lower the piezoelectric brake so that it exerts the proper frictional force on rail 12.

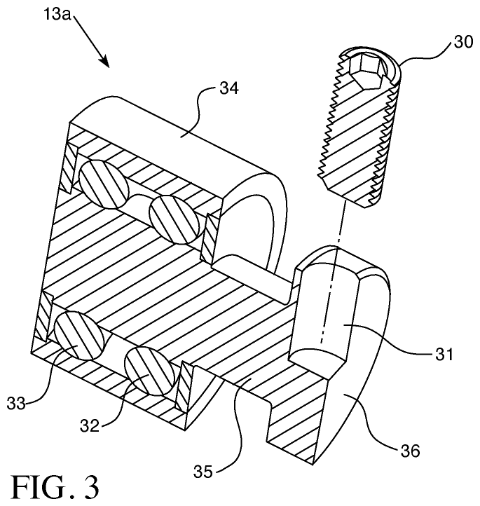

FIG. 3 shows one of the tension rollers, in this case tension roller 13a. Set screw 30 goes into threaded receiver 31 in head 36, which allows the tension roller to be raised or lowered relative to the rail. (NOT SHOWN, see FIG. 6.) Shaft 35 extends from head 36 and is surrounded by roller bearings 32 and 33. The roller bearings can be spherical balls in a race or any other reasonable form of bearing. The roller bearings allow bearing 34 to rotate on shaft 35, keeping the carriage (NOT SHOWN) moving smoothly on the rail (NOT SHOWN) and allowing highly precise alignment of the rail with the carriage as each of the tension rollers can be adjusted individually. The tension rollers are optional, but strongly preferred. If the tension rollers are not used, it is required to have some other form of bearing between the rail and the carriage that can both bear the output load relative to the PLM and provide sufficient reduction of friction to avoid excessive heating or wear of the surfaces of the rail and/or carriage.

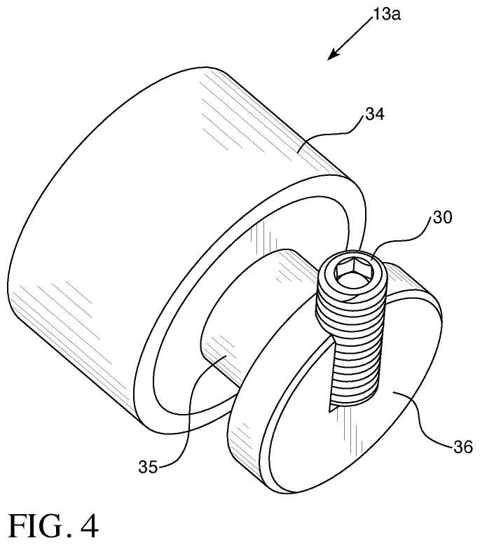

FIG. 4 shows a tension roller 13a with bearing 34 completely enclosing the roller bearings (not shown, see FIG. 3.) Set screw 30 can be raised or lowered in head 36, and adjust the height and/or amount of load on tension roller 13a relative to the carriage (not shown, see FIG. 6) by raising or lowering shaft 35.

It is preferred, but not required, that the tension rollers bear most or all of the load of the carriage and output load relative to the rail.

FIG. 5 shows rail 12 with the tension rollers in the positions they would be in when mounted in the carriage (not shown, see FIGS. 2 and 6.) The tension rollers are set at two different angles, with tension rollers 13a and 13d contacting the lowermost surface of race 50b and tension rollers 13b and 13c contacting the uppermost surface of race 50b. Race 50 is similarly engaged by offset tension rollers so that the carriage is borne on the rail in all dimensions. It is strongly preferred, but not required, to use tension rollers in this embodiment of the invention. If tension rollers are used, it is strongly preferred, but not required, for some to engage a first surface and others to engage a second surface, with the first and second surfaces having an orthogonal or somewhat orthogonal disposition as shown. If this is done, by properly tensioning the tension rollers the carriage will be able to roll freely without displacement in either direction on an axis perpendicular to the direction of travel. This will provide optimum reduction of friction, provide the most secure and efficient alignment of the carriage on the race, and prevent damage to the race and/or bearings by preventing stuttering, skipping, or jumping which might cause the bearings to impact the race surfaces.

Race 12 has braking surfaces 52a and 52b. These surfaces can be engaged by the brake shoes of the piezoelectric brakes (see FIG. 1) to stop or slow the movement of the carriage on the rail.

FIG. 6 shows carriage 17 on the race with the tension rollers in position. Head 36 has been adjusted to the proper tension with set screw 30. Bearing 34 is able to roll freely inside the raceway of race 12. With all the tension rollers similarly tensioned, carriage 17 will roll straight and true along race 12.

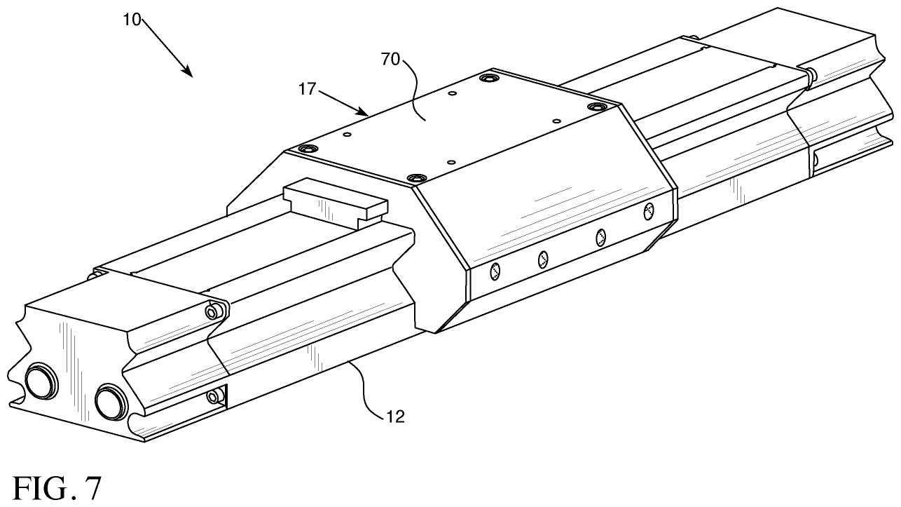

FIG. 7 shows the PLM assembled and ready to use. Carriage 17 is enclosed in cover 70. It is ready to move in either direction along the path of travel defined by rail 12.

It will be apparent to those of ordinary skill in the art that the embodiments herein could be combined in varied combination or as a single unit, granting the improvements of each to a single PLM assembly.

While various embodiments and aspects of the present invention have been described above, it should be understood that they have been presented by way of example only, and not limitation. Thus, the breadth and scope of the present invention should not be limited by any of the above exemplary embodiments.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed and sought to be protected by Letters Patent is:

1. A piezoelectric linear motor comprising:
a) At least one group of piezoelectric actuators, the at least one group of piezoelectric actuators comprising at least one piezoelectric actuator, all of the piezoelectric actuators electrically connected to a power supply;
b) A group of actuator magnets, the group of actuator magnets comprising at least one actuator magnet, each of the at least one piezoelectric actuators mechanically affixed to the group of actuator magnets;
c) A group of response magnets, the group of response magnets physically opposed to the first plurality of piezoelectric elements separated by a variable gap having a size, such that when one or more of the plurality of piezoelectric actuators are energized by the power supply, the size of the variable gap changes;
d) A motor assembly including a mobile assembly and a static assembly, the mobile assembly mechanically affixed to either the group of actuator magnets or the group of response magnets, the static assembly mechanically affixed to whichever of the group of actuator magnets or the group of response magnets the mobile assembly is not mechanically affixed, such that when the size of the variable gap changes, a magnetic force is exerted on the mobile assembly, causing the mobile assembly to move relative to the static assembly;
e) At least one linear rail surface, the at least one linear rail surface running along a length of the static assembly, the length of the static assembly being linear; and,
f) At least one bearing, the bearing operably affixed to the mobile assembly such that the bearing allows the mobile assembly to move along the length of the static assembly, such that the mobile assembly can only move back and forth along a fixed line of travel, the fixed line of travel being parallel to the length of the static assembly.

2. The piezoelectric linear motor as claimed in claim 1, wherein there is one and only one group of piezoelectric actuators, and the one and only one group of piezoelectric actuators comprises one and only one piezoelectric actuator, and there is one and only one group of actuator magnets, and the one and only one group of actuator magnets comprises two actuator magnets.

3. The piezoelectric linear motor as claimed in claim 1, wherein the group of response magnets comprises a single piece of magnetic material, the single piece of magnetic material having a plurality of magnetic regions, each magnetic region having a local north pole and a local south pole.

4. The piezoelectric linear motor as claimed in claim 1, further comprising:
a) A group of actuator magnets, the group of actuator magnets comprising at least one actuator magnet, each of the at least one piezoelectric actuators mechanically affixed to the group of actuator magnets;
b) A group of response magnets, the group of response magnets physically opposed to the first plurality of piezoelectric elements separated by a variable gap having a size, such that when one or more of the plurality of piezoelectric actuators are energized by the power supply, the size of the variable gap changes;

5. The piezoelectric linear motor as claimed in in claim 1, wherein there are two groups of piezoelectric actuators, further comprising:
f) a first group of piezoelectric actuators forming a group of static assembly piezoelectric actuators operably affixed to the static assembly, each of the static assembly piezoelectric actuators mechanically affixed to a static assembly magnet; and,
g) a second group of piezoelectric actuators forming a group of mobile assembly piezoelectric actuators operably affixed to the mobile assembly, each of the mobile assembly piezoelectric actuators mechanically affixed to a mobile assembly magnet.
